(19) United States
(12) Patent Application Publication
(10) Pub. No.: US 2018/0315145 A1
(43) Pub. Date: Nov. 1, 2018

(54) MANAGING SCHOOL SYSTEMS ON A BLOCKCHAIN

(71) Applicant: INTERNATIONAL BUSINESS MACHINES CORPORATION, Armonk, NY (US)

(72) Inventors: Shelby Solomon DARNELL, Yorktown Heights, NY (US); Jonathan LENCHNER, North Salem, NY (US); DABY M. SOW, Croton on Hudson, NY (US); Charity WAYUA, Nairobi (KE); Komminist WELDEMARIAM, Nairobi (KE)

(21) Appl. No.: 15/582,858

(22) Filed: May 1, 2017

(51) Int. Cl. G06Q 50/20; G06F 21/64

(52) U.S. Cl. CPC G06Q 50/205; G06F 21/64

(57) ABSTRACT

A method of managing a school system using a blockchain includes receiving a transaction related to a school record along with chaincodes to validate the transaction and a set of record tokens that represent events with respect to a stakeholder, obtaining a historical block identifier from a blockchain of historical school records that is representative of historical record events in the blockchain, receiving validity requirements for the events on the record, obtaining a validation token that is indicative of a validity of the events based on the set of record tokens, computing a chaincode block for the transaction against the one or more validation requirements as a function of the validation token, the historical school record's block identifier, and the set of record tokens, and creating a new block and upadating the blockchain of historical school records based on the new block the transaction, when the validation succeeds,

### BACKGROUND

### Technical Field

Embodiments of the disclosure are directed to managing school systems using a blockchain.

### Discussion of the Related Art

Addressing the education challenges in developing countries, such as those in sub-Saharan Africa, remains a high priority for local and international governments, donor agencies, and non-governmental agencies (NGOs) across the world. The use of data for decision making, such as resources allocation, has been historically poor and has generated much recent attention. Proper use of data can have a significant impact on the adequate allocation of resources to schools. Today, governments and other responsible entities attempt to use any type of data about students, schools, and resources that may be available in their decision making processes. Specifically, the number and distribution of students, the number and distribution of teachers, the current status of school infrastructure, such as classrooms, utilities, books, etc., and planned expansion programs, such as those due to city expansion and new settlement programs, are factors that need to be accurately estimated to plan resource allocation on an annual basis.

One situation concerns budget allocation. Budget allocation is typically based on an unverifiable number of active students and teachers. Today, as principals report the number of students per school, it is not clear that the numbers reported are accurate. This lack of data quality has significant implications on budget allocation per school and it is estimated that the numbers are geared in favor of the school budget. For example, an overestimate by an average of 10% per school can lead to an excess budget allocation of $50 million for non-existing students. Similarly, while the teacher payroll allocation is centralized, teachers are assigned to specific schools. Hence, teachers that have left the service or do not show up for work may still get paid due to a lack of coordination between the responsible central office and the schools. Using the same example, a 1% number of “ghost teachers” in payroll could amount to almost $20 million a year in losses.

Another issue is spending. Spending on assets is not transparent and therefore not verifiable. School budgets typically depend on the number of enrolled students and incorporate learning resources per student as well as the facilities. The budget is transferred to the school, but the spending of the budget is tracked against invoices issued by 3rd party vendors and not against the actual assets. There are discrepancies between the invoices for purchase of learning materials compared to the actual materials in the classroom. Similarly, the budget allocated for repairs in schools to improve learning environments may not be spent appropriately, but it is not currently possible to provide authoritative proof of work.

A third issue concerns improving the learning environment. There is a limited insight into statistical relationship between school effectiveness and demographic variables. To understand the performance of schools across districts and tie this performance to external conditions, such as the state of the facilities, resources available, and other exogenous factors such as neighborhood income levels, local or in-school violence, health challenges in the area, etc., requires deep understanding of the context of a school. Currently, there is no direct way to correlate a school's performance to such things as teacher absenteeism let alone to such exogenous factors.

Automating the management of school systems will still require participation of the existing internal and external actors, but will help to reduce overhead and increase efficiency by simplifying processes. This will help to standardize the collection of data at fine-granular level that will help to create a single source of truth. Note also that while automating the process, amendments to the existing law and new school regulations may be required. However, the challenges to automating processes include (i) internal (actors across the education systems) and external actors (e.g., suppliers, construction agencies, etc) who may not trust each other or may easily collude; (ii) ensuring the non-repudiation of operations on records by tracking and managing intents such as misuses, frauds, etc; and (iii) ensuring the immutability of operations on school records.

Prior art approaches for maintaining school data include both centralized and decentralized models. With a centralized model, the owner of the school records is trusted to manage operations on records and that person typically also owns the rules. Any operation on the records is trusted by trusting the rules to be appropriate. But, such a model allows for a single point of failure in trust. With a decentralized model, tracking and managing school records is put in the hands of the schools, or possibly in the hands of a number of parties within each of the schools. Such a decentralized model has been used extensively in schools in the developing world, but typically without success. The many opportunities for different parties to edit records provides many opportunities for illicit tampering with the data, e.g., to the advantage of individual students, teachers, schools or even school districts. However, a decentralized model with consensuses, using a trusted identity authority, would enable trusted services with non-repudiation, and by using blockchain, such a system would guarantee immutability of operations/transactions.

Recently, a number of initiatives have proposed using blockchain technology in education. However, all currently proposed blockchain based technologies focus on educational testing, academic certification, and the authentication of degrees. Existing school management systems also do not address the challenges outlined above.

School record management can be used to track lifelong school events in which the records are held in a database by a central owner. In the prior art, school record management systems keep track of events related to school records made by stakeholders, which nonetheless require participation of internal and external actors, upon checking in the records to the database. This is paradoxical, in that without a central database, records can be modified and altered by different stakeholders in different schools as users, such as student, can be transferred between schools, be promoted from level to level, different stakeholders may share a record with each other, etc. In this way, a record can evolve independent of the primary central database.

### SUMMARY

Embodiments of the disclosure are directed to the management of school systems using a blockchain.

According to an embodiment of the disclosure, there is provided a method of managing a school system using a blockchain, including receiving a transaction related to a school record along with one or more chaincodes to validate the transaction, and a set of record tokens that represent events with respect to a stakeholder, obtaining a historical block identifier from a blockchain of historical school records that is representative of historical record events in the blockchain that have been conducted with respect to the record, receiving one or more validity requirements for the events on the record, obtaining a validation token that is indicative of a validity of the events based on the set of record tokens, computing a chaincode block for the transaction against the one or more validation requirements as a function of the validation token, the historical school record's block identifier, and the set of record tokens, and creating a new block and upadating the blockchain of historical school records based on the new block the transaction, when the validation succeeds.

According to a further embodiment of the disclosure, the method includes receiving transactions and their associated data by a cloud-enabled system, performing one or more off-blockchain processing and analytics processes if, based on the context of the transaction, off-blockchain processing and analytics are needed, obtaining one or more chaincodes to validate the transaction, and invoking a validation device to begin blockchain processing.

According to a further embodiment of the disclosure, the method includes receiving from the validation device an indication of whether the validation succeeded or failed, and processing the transaction.

According to a further embodiment of the disclosure, the method includes automatically changing a rate of generating transactions related to a school record based on a risk assessment or context analysis.

According to another embodiment of the disclosure, there is provided an apparatus for managing a school system using a blockchain, including a distributed repository to securely store and maintain school records, a data collector that collects or generates transactions and data to be securely stored on the school record, transaction detector that detects the addition of content to the school records, and a parameter processor that compiles content and parameters and triggers the appending of transactions into the distributed repository based on new content detected by the transaction detector.

According to a further embodiment of the disclosure, the distributed repository is a blockchain.

According to a further embodiment of the disclosure, the school record includes information about one or more of students, teachers, resources and other school records.

According to a further embodiment of the disclosure, triggering the appending of transactions into the distributed repository is further based on one or more customizable parameters, where the customizable parameters include biometric information of a user through the life of the school record or for a period of time, a digital identity of an asset or resource through the life of the school record or for a period of time; analysis results and decisions; information on learning resource through the life of the school record or for a period of time; location, type and profile of a school; class and course offering planning scheduling; utilities, classrooms, maintenance history, budgets, school metadata, school residence type, category, demography, type, and user notifications.

According to a further embodiment of the disclosure, further comprising an analytics module that uses an automatic indexing and clustering system to create personalized summarized views from the distributed repository based on user-specified themes.

According to a further embodiment of the disclosure, the analytics module determines one or more of drop-out rates and patterns, transition patterns, in-take rates, transfer patterns, and resource utilization.

According to a further embodiment of the disclosure, further comprising a resource estimator that estimates resources based on risk assessment and context analyses.

According to another embodiment of the disclosure, there is provided a non-transitory program storage device readable by a computer, tangibly embodying a program of instructions executed by the computer to perform the method steps for managing a school system using a blockchain.

### BRIEF DESCRIPTION OF THE DRAWINGS

FIG. 1 is a block diagram of an exemplary system according to embodiments of the disclosure.

FIG. 2 depicts an exemplary blockchain network setup according to an embodiment.

FIGS. 3A-3B is a flowchart of a workflow according to an embodiment of the disclosure.

FIG. 4 is a flow chart of a method of processing a user query related to a decision support according to an embodiment of the disclosure.

FIG. 5 is a schematic of an exemplary cloud computing node that implements an embodiment of the disclosure.

FIG. 6 shows an exemplary cloud computing environment according to embodiments of the disclosure.

### DETAILED DESCRIPTION OF EXEMPLARY EMBODIMENTS

Exemplary embodiments of the disclosure as described herein generally provide systems and methods for the management of school systems using a blockchain. While embodiments are susceptible to various modifications and alternative forms, specific embodiments thereof are shown by way of example in the drawings and will herein be described in detail. It should be understood, however, that there is no intent to limit the disclosure to the particular forms disclosed, but on the contrary, the disclosure is to cover all modifications, equivalents, and alternatives falling within the spirit and scope of the disclosure.

Embodiments of the disclosure are directed to a school record management challenges related to school administrative activities through the creation of large-scale system for collecting and managing an immutable school records for use in accurate decision making and preventing fraudulent activities. Systems and methods according to embodiments of the disclosure can collect, store and manage school records, assess or validate transactions, such as new student registration, enrollment, student transferring, student promoting, fund transferring, etc., determine or estimate resources based on the records and context analysis, such as budget analysis, risk analysis, etc, and update and display decision activities on end-user devices. Embodiment of the disclosure makes use of a blockchain for lifelong record management that ensures consistency and that records can never be maliciously modified by any individual. Alteration of records can be verified against a particularly useful instance of the record by obtaining a historical block identifier from a school record historical blockchain representative of historical record events from blockchain that have been conducted with respect to this particular instance of the record.

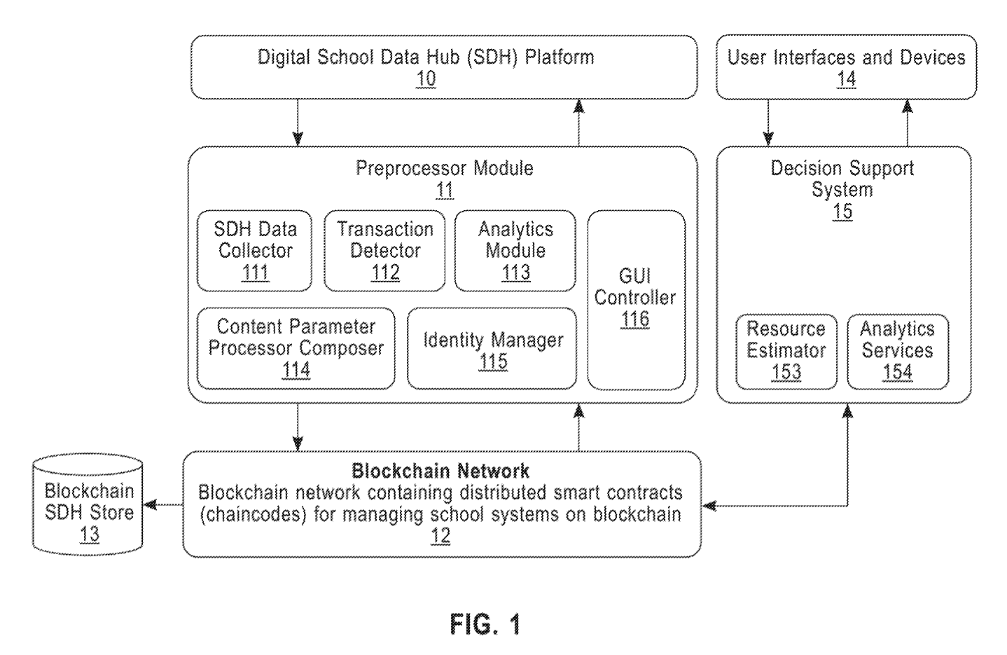

FIG. 1 is a block diagram of an exemplary system according to embodiments of the disclosure. Referring now to the figure, a system according to embodiments includes a student record that includes one or more of a student profile, student attendance, etc., a preprocessor module 11 in communication with a digital school data hub (SDH) platform 10, and also in communication with a blockchain network 12. The SDH platform 10 is a suit of apps that collect, store and manage school records by facilitating the processes of the preprocessor module 11. The blockchain network 12 contains distributed smart contracts (“chaincodes”) for managing school systems on a blockchain, and is connected to a blockchain learner lifelong store 13, which is a ledger that serves as a database for storing school records and chaincodes of the blockchain network 12. The student record is stored on the blockchain SDH store 13. A system according to embodiments of the disclosure further includes user interfaces and devices 14, and a decision support system 15.

A school data hub (SDH) framework 10 according to an embodiment is a suite of apps that can collect, store and manage school records by facilitating various processes in context. The processes include student processes, such as registration, transfers, grade promotions, class enrollment, class performance records, termination and graduation, placement, attendance and assessment. The processes include teacher and administrative staff processes such as registration, transfers, promotion, attendance, deployment and assignment, performance assessment, salary adjustments, hiring and firing. Additional processes include school processes such as registration and resource allocation, and asset processes, such as tracking and facilities and grounds management.

The preprocessor module 11 further includes an SDH data collector 111, a transaction detector 112, a learning analytics module 113, a GUI controller 114, a content/parameter processor/composer 115, and an identity manager 116.

An SDH data collector 111 according to an embodiment collects, prepares or generates transactions and data per student to be securely stored and managed on the student record. A transaction detector 112 according to an embodiment is a module, that detects the addition of content to the record based on the output of the SDH framework, such as user interaction events captured by a digital learning environment, outputs of student behavior analysis, student retention analysis, etc., as indicated by patterns of unusual learning progression for a period of time T, etc. A parameter processor and composer 115 is a module that compiles contents and parameters and then triggers the appending of record transactions associated with a learner into the chain of a historic student's record blockchain, based on new content detected by the transaction detector 112. A learning analytics module 113 is a collection of various analytics models related to risk assessment, drop-out rate, transfer patterns, etc., based on dynamic data captured from the SDH framework 10 and static data such as historical/longitudinal school data.

The identity manager 115 managers the creation of identity, by, e.g., using biometric data such as fingerprints and iris scan data, demographic data, etc., during student registration, facilitates authentication/authorization of students, e,g., during attendance, and manages other identity related services. The GUI Controller 116 controls and maintains the relevant UI elements and UI flows per workflow and to update GUI elements based on signals, such as a notification of an activity being completed, received from a backend or other components, etc. For example, for a registration workflow, the GUI controller loads the UI elements and control logic to control the GUI flows.

The decision support system 15 is equipped with various advanced analytical algorithms that can provide actionable insights about students, teachers, schools and resources for decision makers across various levels, such as teachers, administrators, etc. These capabilities can be built on top of other analytics modules to enable services such as resource allocation, budget allocation, impact assessment, student drop-out pattern forecasting, in-take pattern analysis (i.e., “what types of students are most attracted to this school?”), transfer pattern, student similarity analysis, benchmark analysis, fraud prevention, teacher distribution, school comparison across different demographic variables, and decision support services. A sample decision support question that one might ask is “Given a certain amount of money to spend to improve student retention, what will have the greatest impact?” At the student level, these analytics help decision makers identify risks and needs unique to each learner (so-called “Personalized Learning”) and design personalized interventions that can shift learning trajectories towards desired outcomes.

The decision support system 15 includes an analytics services module 154 that performs analysis services on the blockchain network 12 using an automatic indexing and clustering system that can create personalized summarized views from the blockchain based on a user-specified theme, such as per class, school, county, student index, teacher index, resource index, etc. The analytics services module 154 can further calculate/generate/summarize/forecast drop-out rates/patterns, transition patterns, in-take rate, transfer patterns, resource utilization, etc. The decision support system 15 also includes a resource estimator 153 that can estimate resources is based on risk assessment and context analyses, such as budget analysis, school cohorts, etc., and can use results from the analysis services module 154, such as drop-out rates, in-take rates, assessment of resource utilization, etc., to dynamically adjust/optimize/prioritize budgets.

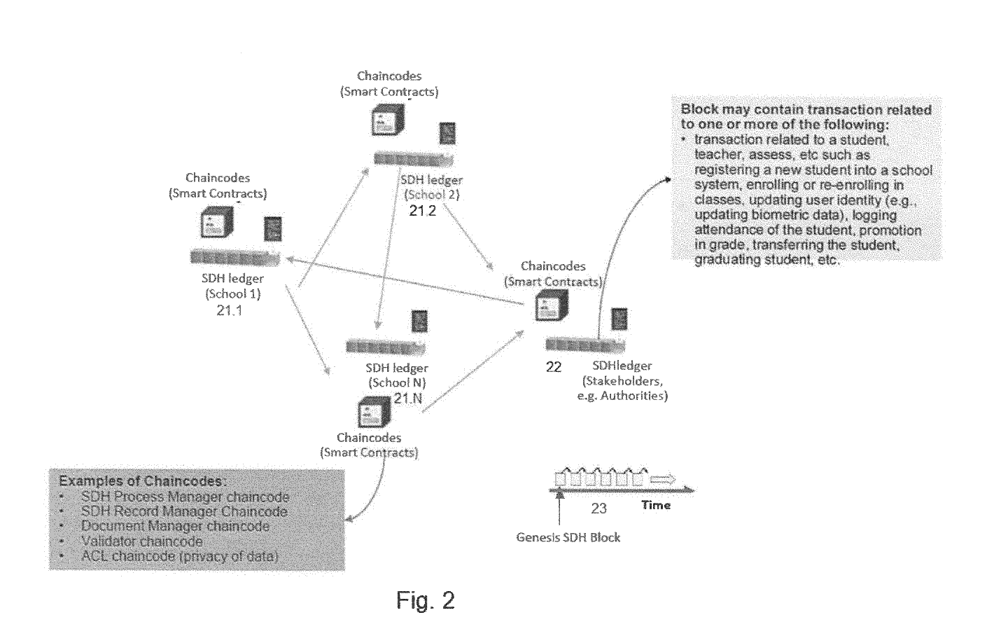

FIG. 2 depicts an exemplary blockchain network setup according to an embodiment. A blockchain network is a collection of smart contracts that can manage lifelong learner events. Referring now to the figure, a blockchain network according to embodiments includes a plurality of SDH nodes 21.1, 21.2., . . . 21.N, one for each educational institution associated with the user, and a user user node 22. Each node includes chaincodes and an associated ledger. Item 23 depicts a genesis learner block of a ledger, which is the very first block in a ledger chain. The ledger chain is a linked list, with each block pointing to its successor. Examples of chaincodes include SDH process manager chaincode, SDH record manager chaincode, document manager chaincode, validator chaincode, and an access control (ACL) chaincode that controls privileges and access rights of a school record. These chaincodes are deployed at each node of the blockchain network for managing school systems. According to embodiments, all the functionalities and services discussed with reference to FIG. 2 are governed by the necessary smart contracts; such as process chaincode ensures the corresponding processes are followed and agreed up on by all the nodes, etc. Each SDH ledger block includes transaction records related to one or more of transactions related to a student, teacher, assessment, etc., such as registering a new student into a school system, enrolling or re-enrolling in classes, updating user identity information, such as biometric data, recording student attendance information, student promotion information, student transfer information, student graduation information, etc.

According to embodiments of the disclosure, a school record includes a student record that includes one or more of a student profile, student attendance, etc., a teacher record that includes one or more of a teacher profile, teacher attendance, teachers social network, teachers cohort, etc., an asset record that details one or more of utilities, classrooms, maintenance history, budget, etc., learning resources, such as contents, curriculums, instruction materials, etc., and any other record, such as school metadata, school residence type, category, demography, type, etc.

According to embodiments of the disclosure, a transaction related to a student record can include: registering a new student into a school system, enrolling or re-enrolling in classes, updating user identity, such as biometric data, logging attendance of the student, promotion in grade, transferring the student, graduating student, termination, placement, etc. A transaction related to a teacher record can include: registering a new teacher into a school system, updating the profile of the teacher, assigning a course to a teacher, promotion, deployment and assignment of teacher, attendance and teaching related transactions such as recording the performance of teacher, etc. Similarly, transactions related to assets, learning resources, classes, etc., include asset registration, uploading/updating curriculum, creating a new course, starting/closing of a course, etc.

According to embodiments of the disclosure, chaincodes are used for validating transactions and controlling off-blockchain data, in which confidentiality, authorization and integrity of data off-blockchain is controlled by workflow and ACL chaincodes. A chaincode is an executable smart contract that is distributed across blockchain nodes in the network that enables interaction with that network's shared ledger. An ACL (Access Control) chaincode is a smart contract that controls the privilege and access rights of a school record. Biometric data, such as fingerprints, iris scans, faces, etc., documents, such as birth certificates, and images, such as those captured by a multimodal school app, are stored outside of the blockchain ledger on secure document store or database. According to embodiments, only hash values of biometric data, documents, images, and any large multimedia data, are stored in the blockchain. Further embodiments use advanced analytical utilities to track and manage records, including dynamically composing and loading templates that are needed for chaincodes based on the type and context of a transaction, e.g., registration (transaction type) of teacher (context of the transaction), registration of classroom, etc.

According to embodiments of the disclosure, transactions associated with a record are compiled into a chain of record transaction blocks, i.e., a blockchain. The chain can be considered a chronicle of a record path through time. When a transaction occurs, one or more corresponding parameters related to administrative events, such as registering a student, transferring a student, enrolling a student for a course, promoting a teacher, assigning a course for a teacher, etc., are recorded. The recorded parameters establish the validity of the transaction and generate a new block. Once the new block has been generated, it can be appended to the historic school's record blockchain.

According to embodiments of the disclosure, a record in the school system has a uniquely identifiable token that is based on by generating a universal UUID, hereinafter referred to as a single token, for the record from properties of the record. For example, for a participant record for a student, teacher, etc., the properties are collected and extracted from the user's biometric information, such as fingerprints, iris, face, voice, etc., and basic information, such as full name, school information, grade, demography, etc., by applying one or more algorithms. For an animate record, a combination of properties of RFID, pictures, etc., can be used to generate the unique token. The use of a blockchain according to embodiments of the disclosure makes this UUID temper-proof and verifiable. In addition, the generated UUID can serve as a unique identify for other services, as its uniqueness is mathematically or cryptographically guaranteed, so that its use is limitless.

According to embodiments of the disclosure, any transaction related to the record includes the UUID of the record. For example, a query for fetching the details of all or part of a record passes the UUID and a public key. Any authorized entity connected to the system can verify the identity of that record as long as they present the UUID as part of the transaction. Note that new record registration for animate records is based on collecting biometric data, where the collection process can include metadata extraction capabilities, such as image analytics using neural networks or visual analytics.

According to embodiments of the disclosure, one or more chaincodes can be invoked for validating transactions related to data collection, by implementing various customized utilities based on existing biometric matching algorithms. Exemplary biometric matching algorithms include iris matching and fingerprint matching, liveness testing algorithms, face detection and matching algorithms for detecting double registration, detecting fraudulent operations, detecting or estimating the gender/age of student/teacher from the images in non-intrusive way, etc.

According to embodiments of the disclosure, various customized parameters related to school records, such as student, teacher, or resource records, etc., can be added to the growing block. These parameters include:
A chronicle of biometric information of a user through the life of the user record, or for a period of time T;
A chronicle of the digital identity of an asset or resource through the life of the asset record, or for a period of time T;
Analysis results and decisions;
A chronicle of information of a learning resource, such as curriculum, instruction materials, etc., through the life of the school system, or for a period of time T;
Geolocation, type of school, profile of school;
Class and course offering planning, including schedules;
Utilities, classrooms, maintenance history, budget, etc., and other records, such as school metadata, school residence type, category, demography, etc.; and
One or more notifications to the user, etc.

According to embodiments of the disclosure, one or more of these parameters can he securely stored and managed in a growing block.

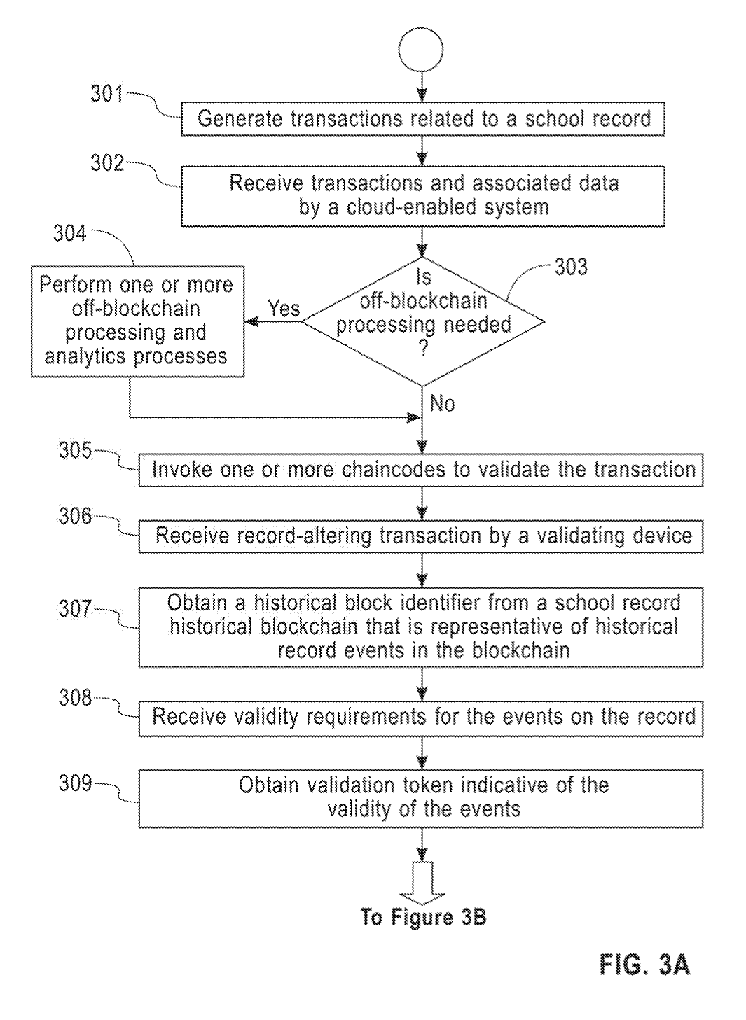

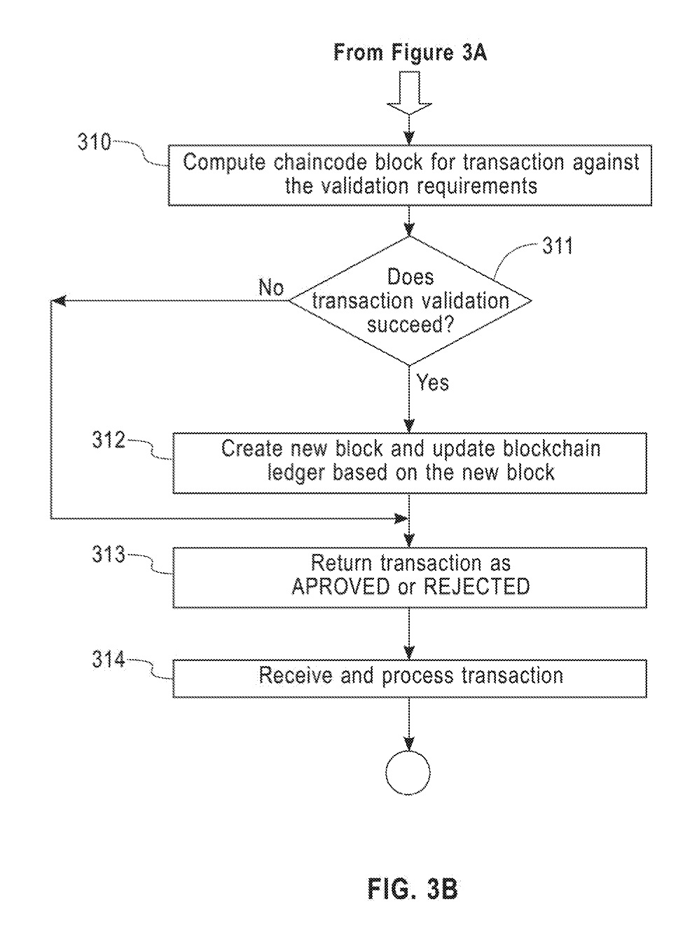

A flowchart of a workflow according to an embodiment of the disclosure is shown in FIGS. 3A-3B. Referring now to FIG. 3A, a workflow begins at step 301 by generating one or more transactions related to a school record, such as a record pertaining to a student, a teacher, an asset, etc. The transactions can be generated by, e.g., a mobile device, a web application, a biometric app or device, etc. At step 302, the transactions and their associated data are received by a cloud-enabled system, which determines whether off-blockchain processing and analytics are needed, at step 303, based on the context of the transaction. If needed, the cloud-enabled system performs, at step 304, one or more off-blockchain processing and analytics processes, such as metadata extraction, fraud detection, etc. The particular process and analytics that are performed are selected based on the context of the transaction, e.g., registering student transaction vs. transferring student transaction. These processes can be performed by, for example, a neural network, visual analytics, obtaining historical events, etc. The cloud-enabled system invokes, at step 305, one or more chaincodes to validate the transaction. Once validated, the transaction is prepared for the blockchain. At step 306, a record-altering transaction is received by a validation device to start blockchain processing. This transaction includes a set of record tokens that represent events with respect to a stakeholder. The events are related to a school record, such as a student record, and include, for example, registering, promoting, transferring, terminating, etc. The stakeholders include school administrators, head teachers, deputy teachers, etc. A validation device obtains, at step 307, a historical block identifier from a school record historical blockchain that is representative of historical record events in the blockchain that have been conducted with respect to the record. The validation device receives, at step 308, one or more validity requirements for the events on the record. At step 309, the validation device obtains a validation token that is indicative of the validity of the events based on a set of record tokens. Continuing to FIG. 3B, at step 310, the validation device computes the chaincode block for the transaction against the validation requirements as a function of the validation token, the historical school record's block identifier, and the set of record tokens. If, at step 311, the transaction validation succeeds, a new block is created at step 312 and the blockchain ledger is updated based on the new block, the transaction is returned as “approved” at step 313, and the transaction is received and processed by the cloud-based system at step 314. If the transaction validation fails, the transaction is returned as “rejected” at step 313 received and processed by the cloud-based system at step 314.

According to embodiments of the disclosure, the record tokens include one or more inputs, such as authorized user (e.g., a school administrator) supplied inputs (e.g. biometric data for registering a new student), analysis execution results (e.g. image analytics on the face image, biometric matching on fingerprint, fraud detection tools, etc), and school cohort and context (e.g. demographic information, calendar, school metadata, etc); and outputs such as de-duplication, forecast of dropout rate, etc.

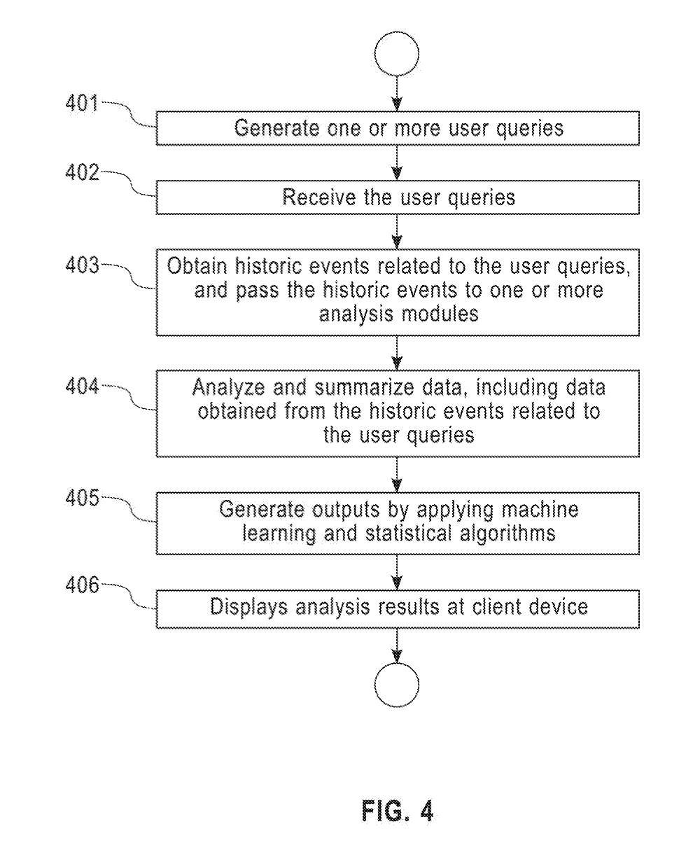

FIG. 4 is a flow chart of a method of processing a user query related to a decision support according to an embodiment of the disclosure. Referring now to the figure, a client device, such as a mobile device, a web application, or a dashboard generates one or more user queries at step 401. The queries may be related to, for example, the percentage gross student intake rate, the percentage drop-out rate, the average student-teacher ratio, the average class size, the total budget allocation vs. actual spending for the financial allocations made to those schools for a given year, etc. The queries are received by a cloud-enables system at step 402 which obtains, at step 403, the historic events related to the user queries, and passes the historic events to one or more analysis modules. At step 404, the one or more analysis modules analyze and summarize a plurality of data, including data obtained from the historic events related to the user queries. At step 405, outputs are generated for the user queries, by applying machine learning and statistical algorithms. At step 406, the client device receives and displays the analysis results.

According to embodiments of the disclosure, chaincode that can be used for validating a registration transaction includes: (1) using templates to analyze registration parameters by matching metadata information; (2) analyzing the school metadata, such as location, electronic calendar, school demography, etc., to validate the permissibility of the transaction (e.g. it is not allowed to register anyone outside of designated location and time); (3) segmenting and extracting information from the biometric data to determine the validity of the raw data by obtaining a historic user's blockchain. Similarly, for all other administrative related transactions, such as enrollment, transfer, promotion, grading, etc., embodiments of the disclosure can use customizable chaincode templates.

In one embodiment, the chaincodes use advanced analytical utilities for tracking and managing records. For example, embodiments of the disclosure can dynamically compose and load templates that are needed for chaincodes based on the type and context of a transaction. A minimum set of parameters needed for a template is determined based on the type and context of a transaction, e,g., registration (transaction type) of teacher (context of the transaction), registration of classroom, etc.

In some embodiments, the frequency of adding to the blockchain is based on a risk assessment or forecast, where the successful addition of a new block triggers an event for updating and displaying decision activities on end-user devices, such as a dashboard, a tablet, a desktop, etc.

Some embodiments use customized analysis services on top of a blockchain or across blockchain networks to calculate patterns using data, such as drop-out rate, transfer patterns, etc. A Bayesian statistical framework can be used that integrates the end-user user theme, the heuristics and theme-relevant characteristics within a unified platform.

According to embodiments of the disclosure, a resource estimation module can use the outputs of Bayesian analysis to estimate or forecast resource needs per school, per county, etc. The resource estimation module can further use context analysis, such as budget analysis, school cohorts, etc., to approximate resource needs.

According to embodiments of the disclosure, a customized analytics services on top of the blockchain networks can intelligently summarize and present key decision factors such as: percentage gross student intake rate, percentage of drop-out rate, average pupil- teacher ratio, average class size, total budget allocation against actual spending for the financial allocations made to those schools for that year, etc. A decision module can use these factors to reason and aggregate using machine learning and statistical algorithms and generate decision activities and update the decision table on end-user devices, such as an interactive dashboard on a mobile device or a web-client.

A system according to an embodiment can use automatic indexing and clustering techniques that can create personalized summarized views from the blockchain network based on a specified theme, such as per class, school, county, student index, teacher index, resource index, etc.

A resource allocation module according to an embodiment can dynamically adjust recommended budgets per school by taking in to consideration any increment or decrement to the total number of students, and an assessment of the school cohort, such as an analysis of classroom condition, an analysis of the facility condition, etc.

A system according to an embodiment can prioritize resource allocation based on school cohort, such as by detecting that a resource index/level for a group of schools is poor compared to other schools with similar number of students, the available budget limit, and an assessment of expected risk for schools. In some embodiments, summaries of prioritization activities can be machine-generated using contextual analysis. In other embodiments, decision-makers, along with teachers, parents, or educational supervisors, etc., will prioritize resource needs based on risk level, resource degradation, population growth, etc. In other embodiment of the disclosure, a physical analysis of facilities obtained using camera, satellite, or drone imaging with neural networks and deep learning can be incorporated onto the historical school's record blockchain.

A further example of advanced, customizable analytics provided by embodiments of the disclosure, is one or more resource allocation modules that dynamically adjust recommended budgets per school by taking in to consideration any increment or decrement to a total number of students, and an assessment of school cohort, such as an analysis of classroom conditions, an analysis of the facility conditions, etc. Further embodiments provide a layered model with smart contracts to mediate the transfer of funds between two distributed ledgers representing participating entities, such as the disbursement of funds to counties and the disbursement of funds from county to schools.

Embodiments of the present disclosure include both systems and methods. Further embodiments include a blockchain system that can track and detect irregularities related to an entity or entities, such as students, teachers, school, assets, etc., and can detect or determine a risk level to a school or school networks, based on the tracking and detection and on advanced analytics, and, based on the risk level, can send alerts or notifications Which can further trigger a signal for controlling a physical system, such as a budget inspection or a building inspection, having the reported irregularities, concern, issue, etc. For example, if the risk level suggests the probability that the student drop-out pattern may effect the distribution of teachers and resources, the signal may then trigger the decision support system for resource allocation and scenario planning

System implementations

It is to be understood that embodiments of the present disclosure can be implemented in various forms of hardware, software, firmware, special purpose processes, or a combination thereof. In one embodiment, an embodiment of the present disclosure can be implemented in software as an application program tangible embodied on a computer readable program storage device. The application program can be uploaded to, and executed by, a machine comprising any suitable architecture. Furthermore, it is understood in advance that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed. An automatic troubleshooting system according to an embodiment of the disclosure is also suitable for a cloud implementation.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources hut may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows

Software as a Service (SaaS): the capability provided to the consumer is to use the provider's applications running on a cloud infrastructure. The applications are accessible from various client devices through a thin client interface such as a web browser web-based email). The consumer does not manage or control the underlying cloud infrastructure including network, servers, operating systems, storage, or even individual application capabilities, with the possible exception of limited user-specific application configuration settings.

Platform as a Service (Paas): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises,

Community cloud: the cloud infrastructure is shared by several organizations and supports a specific community that has shared concerns (e.g., mission, security requirements, policy, and compliance considerations). It may be managed by the organizations or a third party and may exist on-premises or off premises,

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

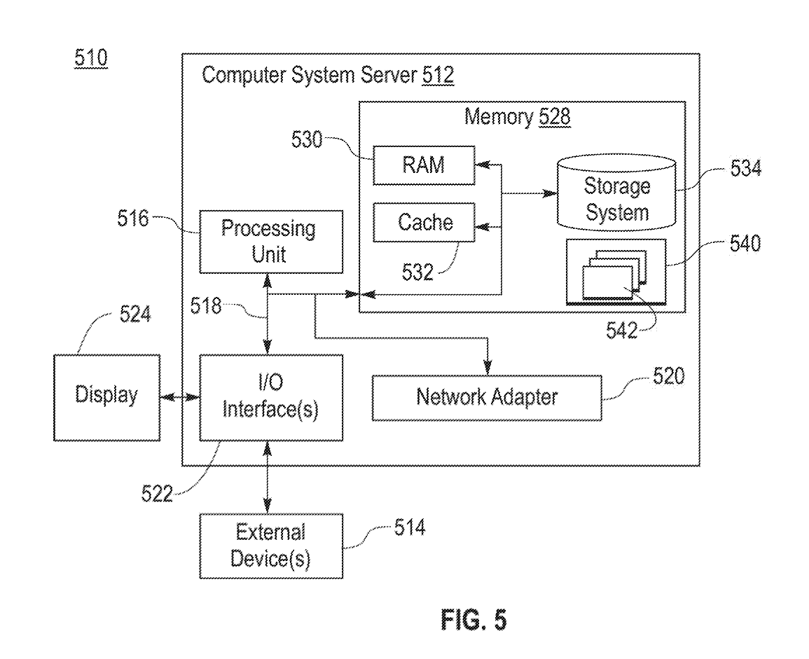

Referring now to FIG. 5, a schematic of an example of a cloud computing node is shown. Cloud computing node 510 is only one example of a suitable cloud computing node and is not intended to suggest any limitation as to the scope of use or functionality of embodiments of the disclosure described herein. Regardless, cloud computing node 510 is capable of being implemented and/or performing any of the functionality set forth hereinabove.

In cloud computing node 510 there is a computer system/server 512, which is operational with numerous other general purpose or special purpose computing system environments or configurations. Examples of well-known computing systems, environments, and/or configurations that may be suitable for use with computer system/server 512 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 512 may be described in the general context of computer system executable instructions, such as program modules, being executed by a computer system. Generally, program modules may include routines, programs, objects, components, logic, data structures, and so on that perform particular tasks or implement particular abstract data types. Computer system/server 512 may be practiced in distributed cloud computing environments is where tasks are performed by remote processing devices that are linked through a communications network. In a distributed cloud computing environment, program modules may be located in both local and remote computer system storage media including memory storage devices.

As shown in FIG. 5, computer system/server 512 in cloud computing node 510 is shown in the form of a general-purpose computing device. The components of computer system/server 512 may include, but are not limited to, one or more processors or processing units 516, a system memory 528, and a bus 518 that couples various system components including system memory 528 to processor 516.

Bus 518 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EIS) bus, Video Electronics Standards Association (VESA) local bus, and Peripheral Component Interconnect (PCI) bus.

Computer system/server 512 typically includes a variety of computer system readable media. Such media may be any available media that is accessible by computer system/server 512, and it includes both volatile and non-volatile media, removable and non-removable media.

System memory 528 can include computer system readable media in the form of volatile memory, such as random access memory (RAM) 530 and/or cache memory 532. Computer system/server 512 may further include other removable/non-removable, volatile/non-volatile computer system storage media. By way of example only, storage system 534 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 518 by one or more data media interfaces. As will be further depicted and described below, memory 528 may include at least one program product having a set (e.g., at least one) of program modules that are configured to carry out the functions of embodiments of the disclosure.

Program/utility 540, having a set (at least one) of program modules 542, may be stored in memory 528 by way of example, and not limitation, as well as an operating system, one or more application programs, other program modules, and program data. Each of the operating system, one or more application programs, other program modules, and program data or some combination thereof, may include an implementation of a networking environment. Program modules 542 generally carry out the functions and/or methodologies of embodiments of the disclosure as described herein.

Computer system/server 512 may also communicate with one or more external devices 514 such as a keyboard, a pointing device, a display 524, etc.; one or more devices that enable a user to interact with computer system/ server 512; and/or any devices (e.g., network card, modem, etc.) that enable computer system/server 512 to communicate with one or more other computing devices. Such communication can occur via Input/Output (I/O) interfaces 522. Still yet, computer system/server 512 can communicate with one or more networks such as a local area network (LAN), a general wide area network (WAN), and/or a public network (e.g., the Internet) via network adapter 520. As depicted, network adapter 520 communicates with the other components of computer system/server 512 via bus 518. It should be understood that although not shown, other hardware and/or software components could be used in conjunction with computer system/server 512. Examples, include, but are not limited to: microcode, device drivers, redundant processing units, external disk drive arrays, RAID systems, tape drives, and data archival storage systems, etc.

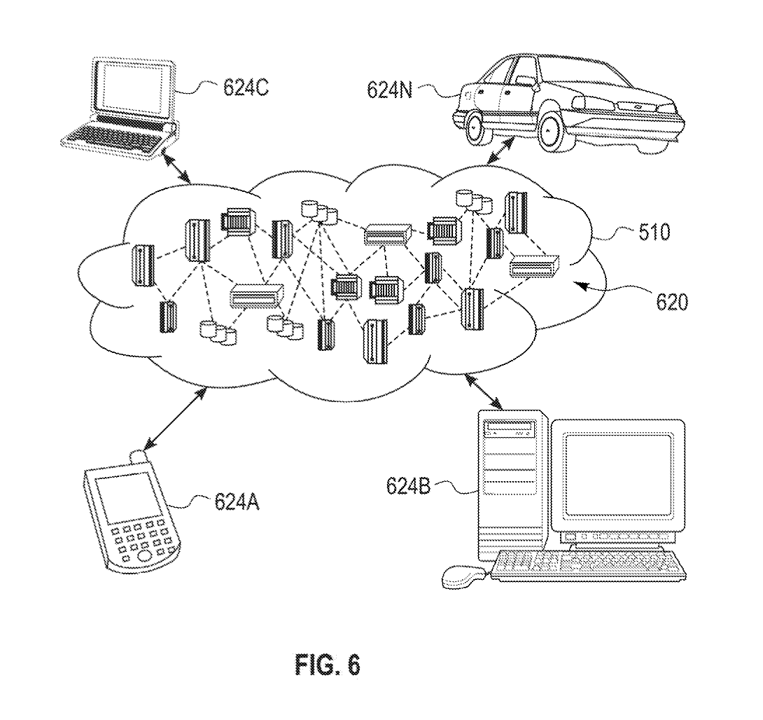

Referring now to FIG. 6, illustrative cloud computing environment 620 is depicted. As shown, cloud computing environment 620 comprises one or more cloud computing nodes 510 with which local computing devices used by cloud consumers, such as, for example, personal digital assistant (PDA) or cellular telephone 624A, desktop computer 624B, laptop computer 624C, and/or automobile computer system 624N may communicate. Nodes 510 may communicate with one another. They may be grouped (not shown) physically or virtually, in one or more networks, such as Private, Community, Public, or Hybrid clouds as described hereinabove, or a combination thereof. This allows cloud computing environment 620 to offer infrastructure, platforms and/or software as services for which a cloud consumer does not need to to maintain resources on a local computing device. It is understood that the types of computing devices 624A-N shown in FIG. 6 are intended to be illustrative only and that computing nodes 510 and cloud computing environment 620 can communicate with any type of computerized device over any type of network and/or network addressable connection (e.g., using a web browser).

While embodiments of the present disclosure has been described in detail with reference to exemplary embodiments, those skilled in the art will appreciate that various modifications and substitutions can be made thereto without departing from the spirit and scope of the disclosure as set forth in the appended claims.

What is claimed is:

1. A method of managing a school system using a blockchain, comprising the steps of:
receiving a transaction related to a school record along with one or more chaincodes to validate the transaction, and a set of record tokens that represent events with respect to a stakeholder;
obtaining a historical block identifier from a blockchain of historical school records that is representative of historical record events in the blockchain that have been conducted with respect to the record;
receiving one or more validity requirements for the events on the record;
obtaining a validation token that is indicative of a validity of the events based on the set of record tokens;
computing a chaincode block for the transaction against the one or more validation requirements as a function of the validation token, the historical school record's block identifier, and the set of record tokens; and
creating a new block and upadating the blockchain of historical school records based on the new block the transaction, when the validation succeeds.

2. The method of claim 1, further comprising:
receiving transactions and their associated data by a cloud-enabled system;
performing one or more off-blockchain processing and analytics processes if, based on the context of the transaction, off-blockchain processing and analytics are needed;
obtaining one or more chaincodes to validate the transaction; and
invoking a validation device to begin blockchain processing,

3. The method of claim 2, further comprising receiving from the validation device an indication of whether the validation succeeded or failed, and processing the transaction.

4. The method of claim 1, further comprising automatically changing a rate of generating transactions related to a school record based on a risk assessment or context analysis.

5. An apparatus for managing a school system using a blockchain, comprising:
a distributed repository to securely store and maintain school records;
a data collector that collects or generates transactions and data to be securely stored on the school record;
transaction detector that detects the addition of content to the school records; and
a parameter processor that compiles content and parameters and triggers the appending of transactions into the distributed repository based on new content detected by the transaction detector.

6. The apparatus of claim 5, wherein the distributed repository is a blockchain.

7. The apparatus of claim 5, wherein the school record includes information about one or more of students, teachers, resources and other school records.

8. The apparatus of claim 5, wherein triggering the appending of transactions into the distributed repository is further based on one or more customizable parameters, wherein the customizable parameters include biometric information of a user through the life of the school record or for a period of time, a digital identity of an asset or resource through the life of the school record or for a period of time; analysis results and decisions; information on learning resource through the life of the school record or for a period of time; location, type and profile of a school; class and course offering planning scheduling; utilities, classrooms, maintenance history, budgets, school metadata, school residence type, category, demography, type, and user notifications.

9. The apparatus of claim 5, further comprising an analytics module that uses an automatic indexing and clustering system to create personalized summarized views from the distributed repository based on user-specified themes.

10. The apparatus of claim 9, wherein the analytics module determines one or more of drop-out rates and patterns, transition patterns, in-take rates, transfer patterns, and resource utilization.

11. The apparatus of claim 5, further comprising a resource estimator that estimates resources based on risk assessment and context analyses.

12. A non-transitory program storage device readable by a computer, tangibly embodying a program of instructions executed by the computer to perform the method steps for managing a school system using a blockchain, comprising the steps of:
receiving a transaction related to a school record along with one or more chaincodes to validate the transaction, and a set of record tokens that represent events with respect to a stakeholder;
obtaining a historical block identifier from a blockchain of historical school records that is representative of historical record events in the blockchain that have been conducted with respect to the record;
receiving one or more validity requirements for the events on the record;
obtaining a validation token that is indicative of a validity of the events based on the set of record tokens;
computing a chaincode block for the transaction against the one or more validation requirements as a function of the validation token, the historical school record's block identifier, and the set of record tokens; and
creating a new block and upadating the blockchain of historical school records based on the new block the transaction, when the validation succeeds.

13. The computer readable program storage device of claim 12, the method further comprising:
receiving transactions and their associated data by a cloud-enabled system;
performing one or more off-blockchain processing and analytics processes if, based on the context of the transaction, off-blockchain processing and analytics are needed;
obtaining one or more chaincodes to validate the transaction; and
invoking a validation device to begin blockchain processing.

14. The computer readable program storage device of claim 13, the method thither comprising receiving from the validation device an indication of whether the validation succeeded or failed, and processing the transaction.

15. The computer readable program storage device of claim 12, the method further comprising automatically changing a rate of generating transactions related to a school record based on a risk assessment or context analysis.
